(19) United States
(12) Patent Application Publication
(10) Pub. No.: US 2002/0091706 A1
(43) Pub. Date: Jul. 11, 2002

(54) Vehicle history and personalization information management system and method

(75) Inventors: Jonathan Stuart Anderson, Grand Rapids, MI (US); Lynne Marie Bosgraaf, Grand Haven, MI (US); Thomas Joseph Czaplicki, Hudsonville, MI (US); Stephanie Joy Elhart, Holland, MI (US); Michael John Suman, Holland, MI (US); Kim Lyle Van Order, Hamilton, MI (US); James Richard Geschke, Holland, MI (US); John Michael Waraniak, West Bloomfield, MI (US); Mark Lewis Zeinstra, Holland, MI (US)

Correspondence Address: Alistair K. Chan, Foley & Lardner, Firstar Center, 777 East Wisconsin Avenue, Milwaukee, WI, 53202-5367, US

(73) Assignee: JOHNSON CONTROLS TECHNOLOGY COMPANY

(21) Appl. No.: 09/948,139

(22) Filed: Sep. 6, 2001

Related U.S. Application Data
(60) Provisional application No. 60/230,274, filed on Sep. 6, 2000.

(51) Int. Cl. G06F 17/00; G06F 17/60

(52) U.S. Cl. 707/104.1; 709/217; 705/1

(57) ABSTRACT

A vehicle history and personalization system accessible by a plurality of users is disclosed. The vehicle history and personalization system includes a communications network. The vehicle history and personalization system also includes a server computer in communication with the communications network and a client computer in communication with the communications network. The vehicle history and personalization system further includes a vehicle history database accessible by the server computer. The vehicle history database includes information for individual vehicle relating to the design and manufacturing history of the individual vehicle. The vehicle history and personalization system also includes a program running on the server computer. The program is configured to provide access to the vehicle specific data stored in the vehicle history database based on a vehicle's specific identifier provided to the server computer by the client computer.

### CROSS-REFERENCE TO RELATED PATENT APPLICATIONS

This application claims the benefit of U.S. Provisional Patent Application No. 60/230,274 filed on Sep. 6, 2000, the entirety of which is herein incorporated by reference.

### BACKGROUND

The internet includes a communications network linking a vast number of computers with smaller computers and computer networks. The computers coupled to these networks exchange information using various services, such as electronic mail, gopher, and the world wide web (WWW). The world wide web allows a computer server (sometimes referred to as a web server or a web site) to send graphical web page information to a remote client computer system. The remote client computer system is configured to display the web page information in a graphical format.

Resources such as individual computers or individual web pages on the world wide web may be uniquely identified by a uniform resource locator (URL). For a user to view a specific web page, a client computer system specifies the URL for that web page in a request, such as a hyper-text transfer protocol (http) request. The request is forwarded through the communications network to the web server that supports the particular web page. The web server responds to the request by sending the particular web page to the requesting client computer system. When the requesting client computer system receives the particular web page, the particular web page is displayed on a video display using a browser. The browser is typically a special-purpose application program that effects the requesting of web pages and the supplying of web pages.

The web pages themselves are typically defined using a hyper-text markup language (HTML) or an extensible markup language (XML). HTML simply provides a standard set of tags that define how a web page is to be displayed. When a user indicates to the browser to display a web page, the browser sends a request to the server computer system to transfer to the client computer system an HTML document that defines the web page. When the requested HTML document is received by the client computer system, the browser displays the web page as defined by the HTML document. The HTML document contains various tags that control the displaying of text, graphics, controls, and other features. The HTML document may further contain URLs of other web pages available on that server computer system or other server computer systems, these URLs are often referred to as links. Each of these links may be selected by the HTML document user and an http request is sent to the associated web server.

Although the origins of the world wide web were born from the need for an exchange of scientific and engineering information between scientists and engineers, the world wide web has become specially conducive to conducting electronic commerce (e-commerce) including business-to-business (B2B) commerce. Numerous web servers exist through which vendors and suppliers can advertise and sell products. Products include items that are delivered electronically to the purchaser over the internet (e.g., software and music) and items (e.g., books, toys, and furniture, etc.) that are delivered through conventional distribution channels (e.g., common carriers such as mail delivery and similar services). Web servers may provide electronic catalogs listing items that are available for purchase. These on-line catalogs may be browsed using a browser and various items to be purchased may be selected. In a conventional transaction, a user selects a number of items to be purchased. The server computer system prompts the user for information to complete the order of items. Purchaser-specific information may include the purchaser's name, purchaser's credit card number, and shipping address for the order. The server computer system typically confirms the order by sending a confirming web page to the client computer system and schedules shipment of the items. Further, the server computer system often sends a confirmation e-mail to the purchaser confirming that an order has been sent.

The inventions relate to an information management system for a product. Further, the inventions relate to an information management system and method for reviewing vehicle history over a communications network. Yet further still, the inventions relate to reviewing of and storage of vehicle history information over a communications network and utilizing such information to apprise the vehicle owner of conditions and opportunities available to the user concerning the vehicle.

Typically when an individual purchases an automobile, the purchaser has no centralized location for obtaining the history related to the individual vehicle itself and to the general design history of the vehicle. Further, a user usually retains paper copies of service and warranty records for later reference. Further still, the vehicle owner has no centralized location for gaining access to service and warranty information, vehicle history information, as well as after market product offerings, telematics for the vehicle, after market services, dealerships, and the like. Communication networks enable a large number of users of certain applications to gain access to information from a variety of locations. Accordingly, there is a need for a centralized application and/or database which provides access to and/or links to vehicle history information for a particular vehicle, for a general class of vehicles, service and warranty information for an individual vehicle, after market product offerings for an individual vehicle, telematics for an individual vehicle, service and dealer links for an individual vehicle, and other types of database information and links. Further, there is a need for a central environment for a vehicle owner to manage and gain access to information regarding the owner's vehicle.

It would be desirable to provide a system and/or method that provides one or more of these or other advantageous features. Other features and advantages will be made apparent from the present specification. The teachings disclosed extend to those embodiments which fall within the scope of the appended claims, regardless of whether they accomplish one or more of the above-mentioned needs.

### SUMMARY

One embodiment of the invention relates to a vehicle history system accessible by a plurality of users. The system comprises a communications network, a server computer in communication with the communications network, and a client computer in communication with the communications network. The system also includes a vehicle history database accessible by the server computer, the vehicle history database including information for an individual vehicle relating to the design and manufacturing history of the individual vehicle. Further, the system includes a program running on the server computer, the program configured to provide access to vehicle specific data stored in the vehicle history database, based on a vehicle specific identifier provided to the server computer by the client computer.

Another embodiment of the invention relates to an on-line environment for accessing vehicle history. The environment includes a display, a graphical user interface running on a computer and being viewed on the display, and a communications network in communication with the computer and having access to a vehicle history database. The environment also includes a vehicle identifier field configured to utilize a vehicle identification number (VIN) to provide access to vehicle specific data, including vehicle history data and vehicle information data, the vehicle history data including information for individual vehicles relating to the design and manufacturing history of the individual vehicle.

Yet another exemplary embodiment of the invention relates to a method of retrieving vehicle specific data. The method includes receiving over a communications network, from a user of a client computer a vehicle specific identifier, retrieving over the communications network, from a database, vehicle history information, and providing over the communications network, to the client computer, vehicle history information for the specific vehicle. The vehicle history database includes information for individual vehicles relating to the design and manufacturing history of the individual vehicle, and providing over the communications network, access to vehicle specific data.

Yet still another exemplary embodiment of the invention relates to a vehicle personalization system. The vehicle personalization system includes a communications network, a server computer in communication with the communications network, and a client computer in communication with the communications network. The vehicle personalization system also includes a vehicle personalization database accessible by the server computer, the vehicle personalization database including information for an individual vehicle relating to the customization of the individual vehicle;

a program running on the server computer, the program configured to provide access to vehicle specific data stored in the vehicle personalization database, based on a vehicle specific identifier provided to the server computer by the client computer.

Alternative exemplary embodiments relate to other features and combination of features as may be generally recited in the claims.

### BRIEF DESCRIPTION OF THE DRAWINGS

The invention will become more fully understood from the following detailed description, taken in conjunction with the accompanying drawings, wherein like reference numerals refer to like elements, in which:

FIG. 1 depicts a generalized client server communication network;

FIG. 2 depicts a vehicle history information system front end user interface;

FIG. 3 depicts a general vehicle information screen for the vehicle history information system;

FIG. 4 depicts a user interface for services and warranty information;

FIGS. 4A-4D depict a data entry screen for entering vehicle history information;

FIGS. 4E-4F depict a link screen for features, services, warranty, history, and product offering information for a vehicle history information system;

FIG. 5 is a depiction of a personalization user interface;

FIG. 5A-F are depictions of vehicle setting user interfaces;

FIG. 6 is a depiction of a vehicle products user interface;

FIGS. 6A-6D are depictions of vehicle product user interface features;

FIG. 7 is a depiction of a vehicle services user interface;

FIGS. 7A-7C are depictions of exemplary vehicle services features; and

FIG. 8 is a depiction of an exemplary embodiment of an introductory user interface for a vehcile history and personalization information system.

### DETAILED DESCRIPTION OF EXEMPLARY EMBODIMENTS

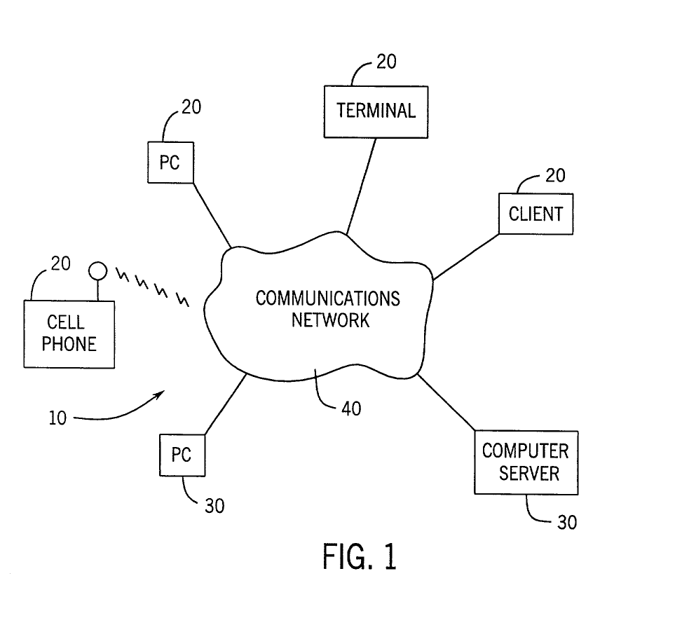

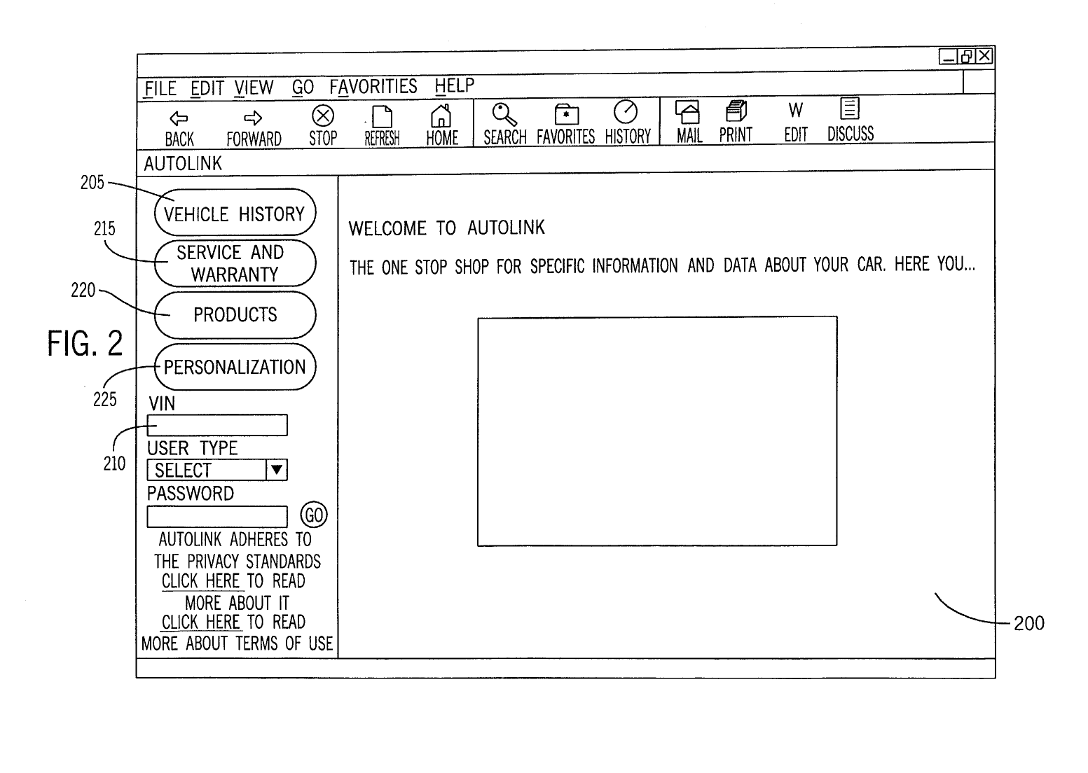

Referring to FIG. 1, in an exemplary embodiment an information system 10 includes a plurality of clients 20 and servers 30 in communication with a communications network 40. Communications network 40 may be, in an exemplary embodiment, any of a variety of communications networks including local networks such as, but not limited to token ring networks, Ethernet networks, intranetworks, and non-local networks, such as, but not limited to the internet, telephone networks, cable networks, satellite networks and other wireless, wired, and/or hybrid networks. Clients 20 may include but are not limited to a variety of information interface devices, including but not limited to computer terminal devices, personal computers, other microprocessor based devices, such as but not limited to personal data assistants (PDAs), cellular telephones, pagers, telephones, televisions, and the like. In an exemplary embodiment servers 30 may include a variety of microprocessor devices, including but not limited to personal computers, mainframe and supercomputers, computer servers, and other types of microprocessor devices capable of storing information and being programmed to run a plurality of programmed steps and/or routines. The user interfaces, programs, applications, and information resources, hereinafter described, may all be made available over a communications network, such as, but not limited to communications network 40. Programs, websites, applications, information services, may be hosted on servers, such as servers 30 and accessed by clients, such as clients 20.

Referring now to FIG. 2, a front end user interface for a personal vehicle history application 200 is depicted. The personal vehicle history application 200 is an information environment for accessing and providing specific information and data about an owner's automobile or other vehicles. Use of application 200 allows a user to access a vehicle's history (by selecting vehicle history link 205) from the broadcast date to present. The vehicle history application also provides detailed service history and specific performance issues. Also, search for information about types of vehicles, parts, and accessories and topics related to a user's automobile may be searched. Additionally, several portals may be enabled which allow a user to access and work with services and data in a variety of ways. In an exemplary embodiment, personal vehicle information application 200 will tie vehicle history to the vehicle identification number (VIN) which may be provided in field 210 and be able to supply service and warranty information (via service and warranty link 215), after market product offerings (via product link 220), telematics for the vehicle, among others informational links (such as, but not limited to personalization link 225).

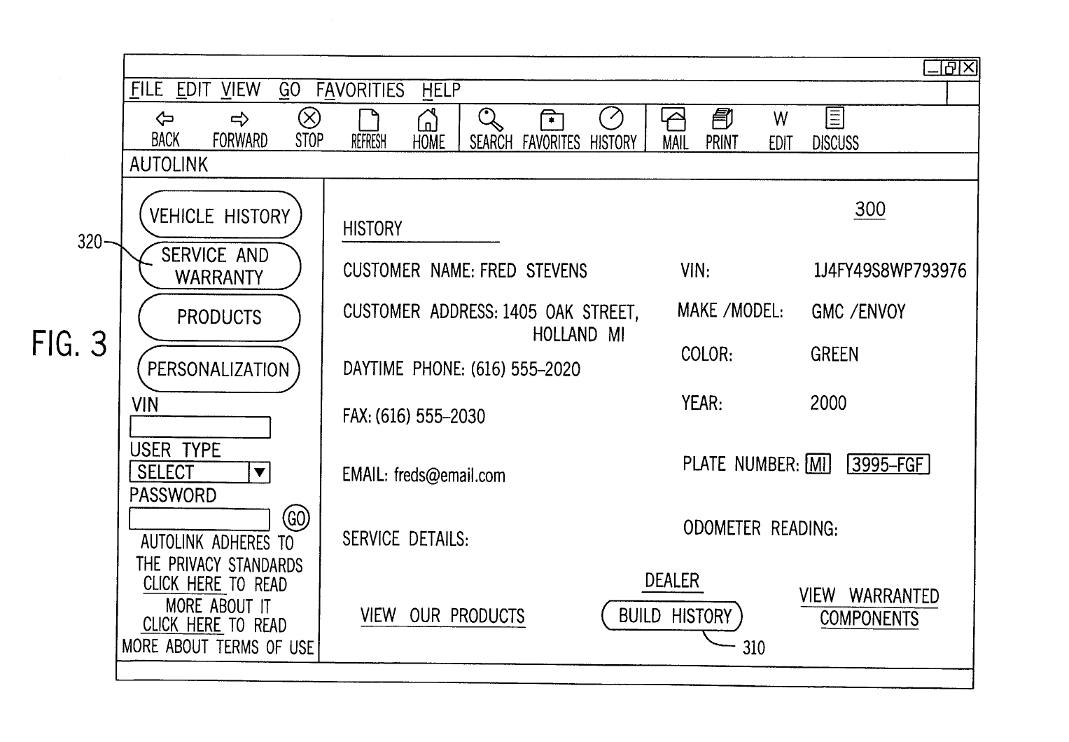

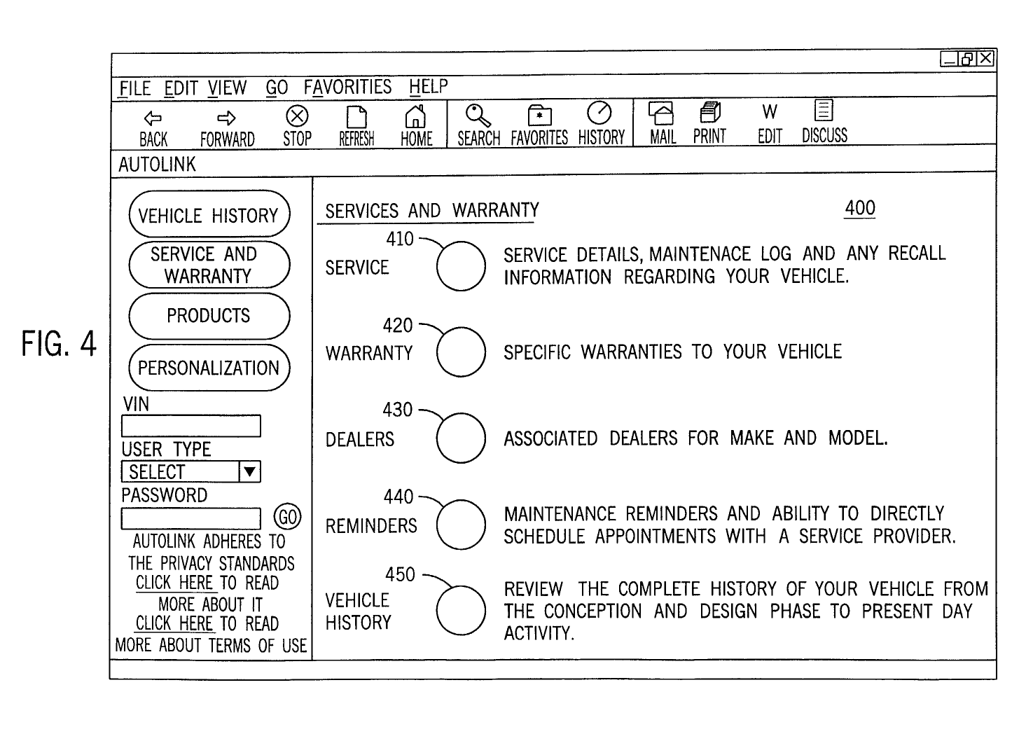

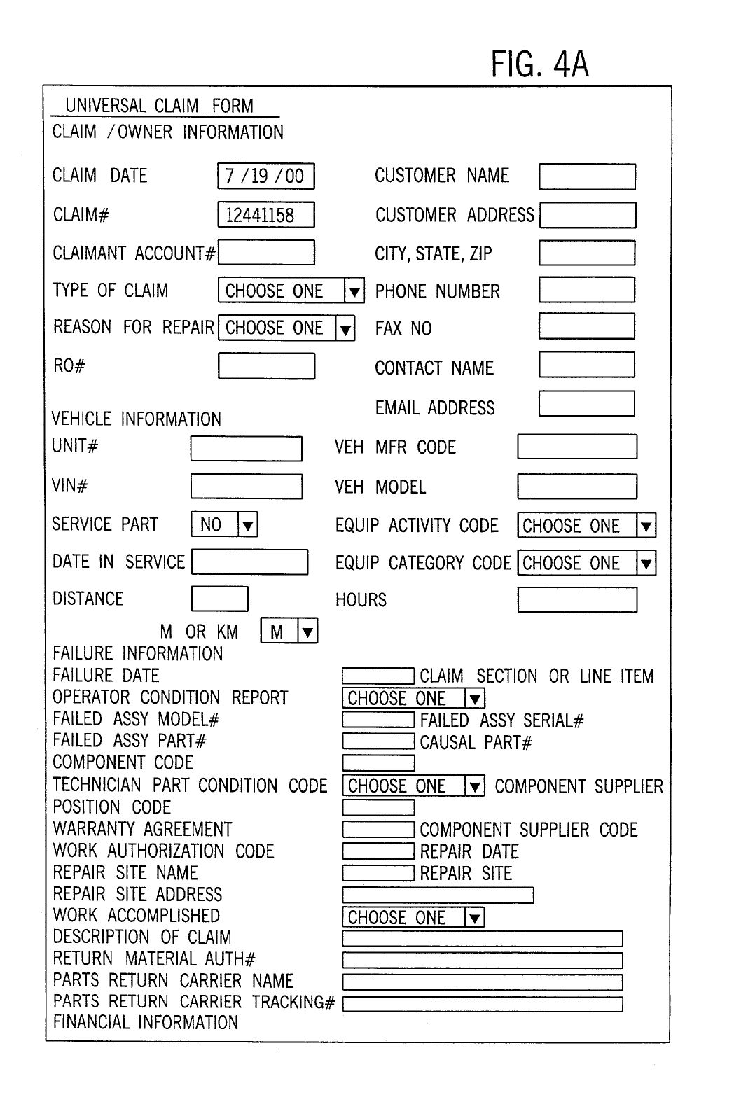

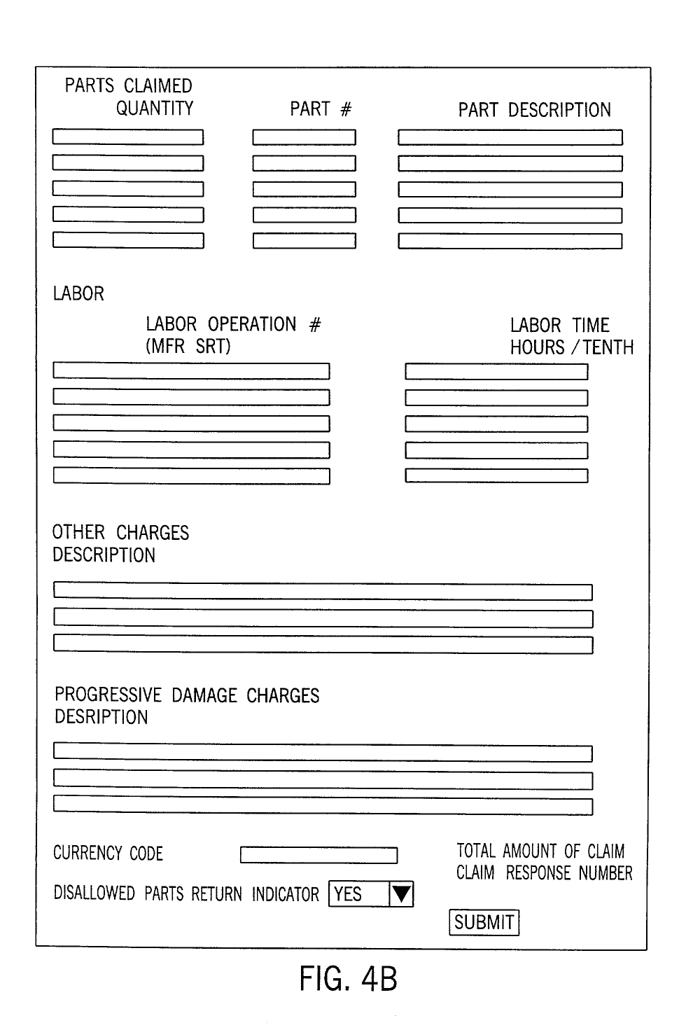

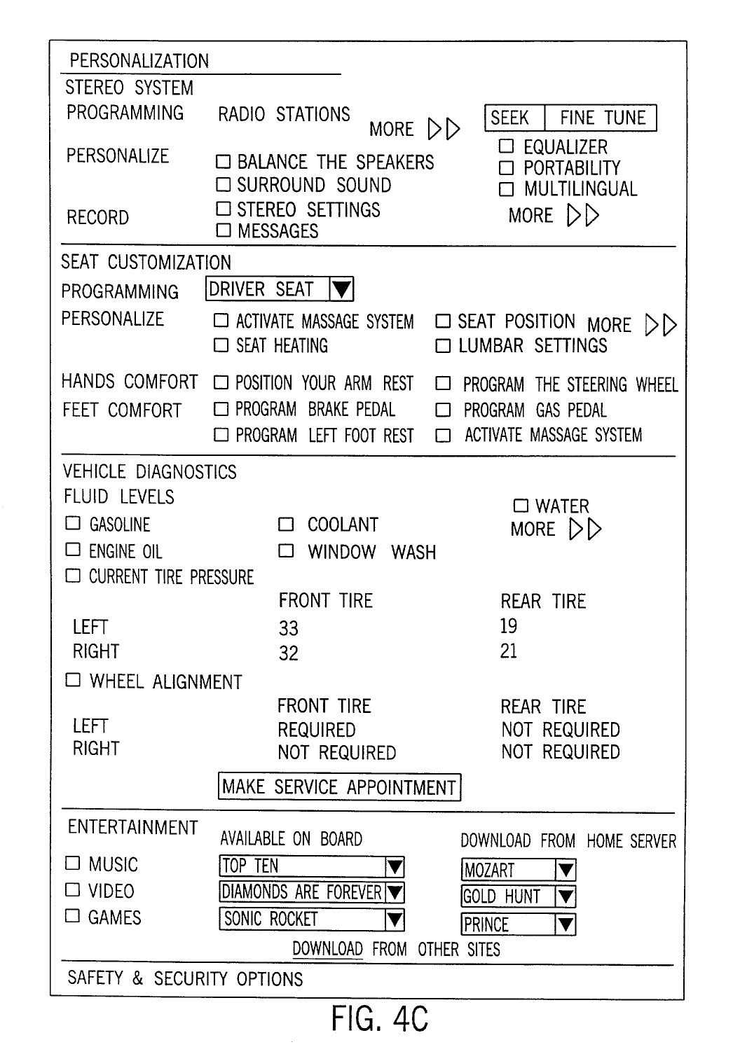

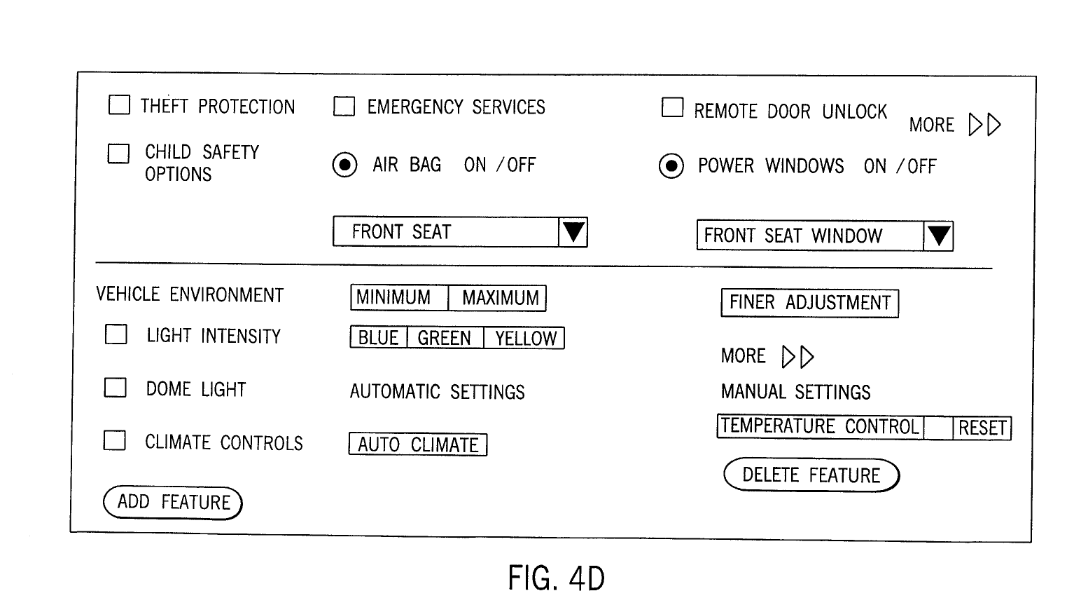

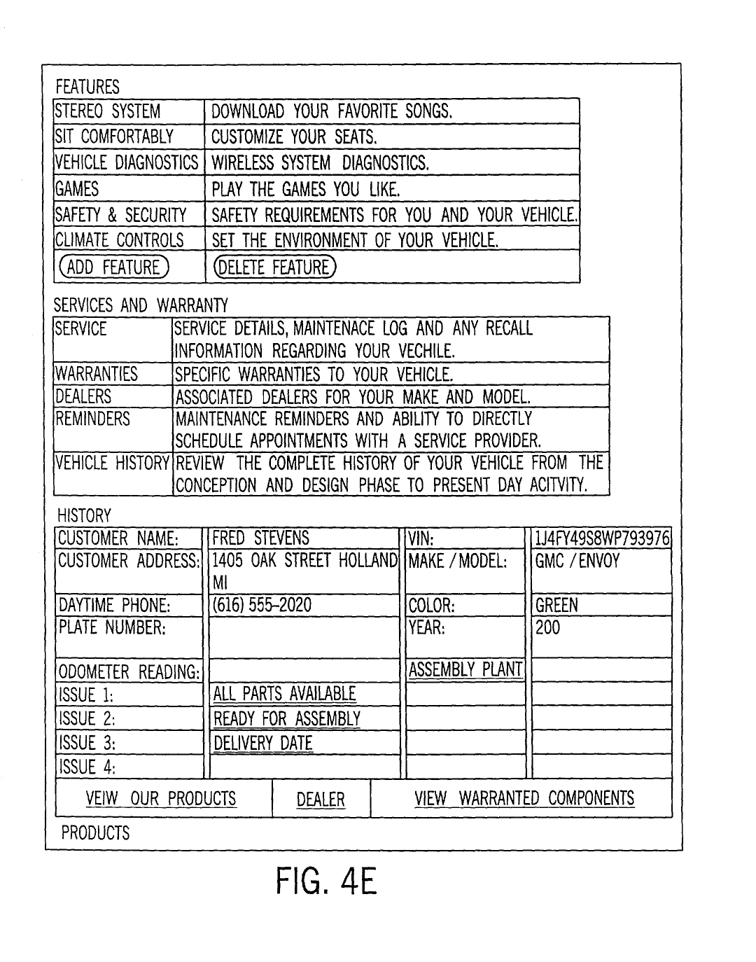

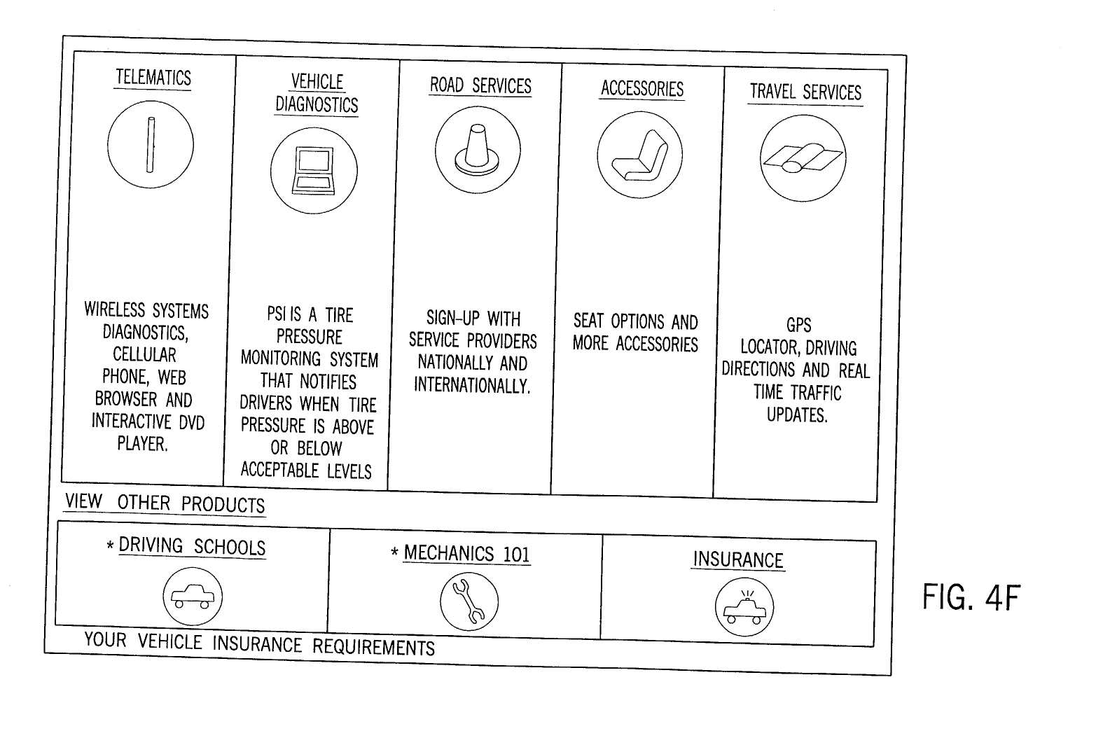

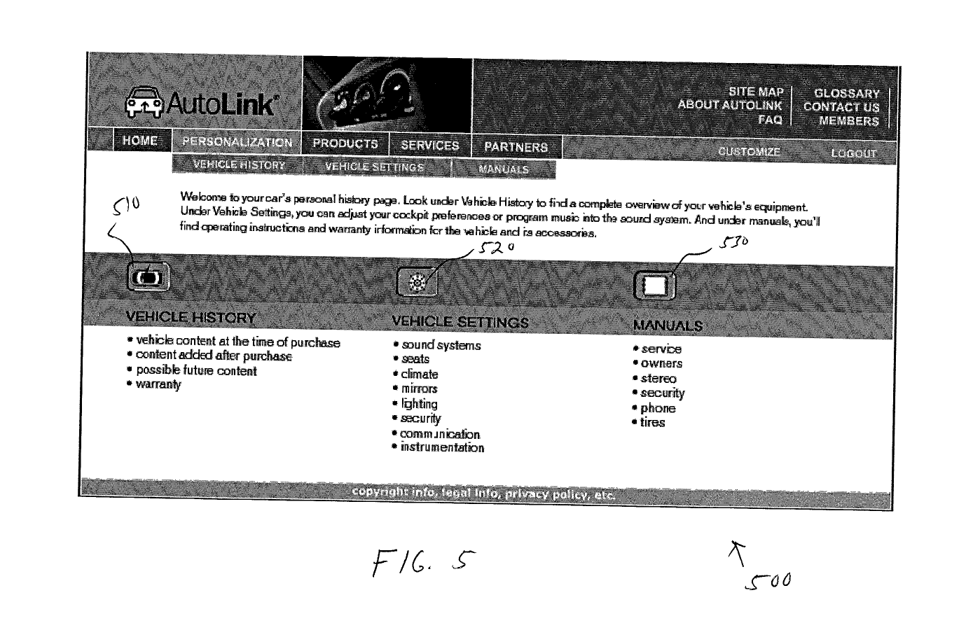

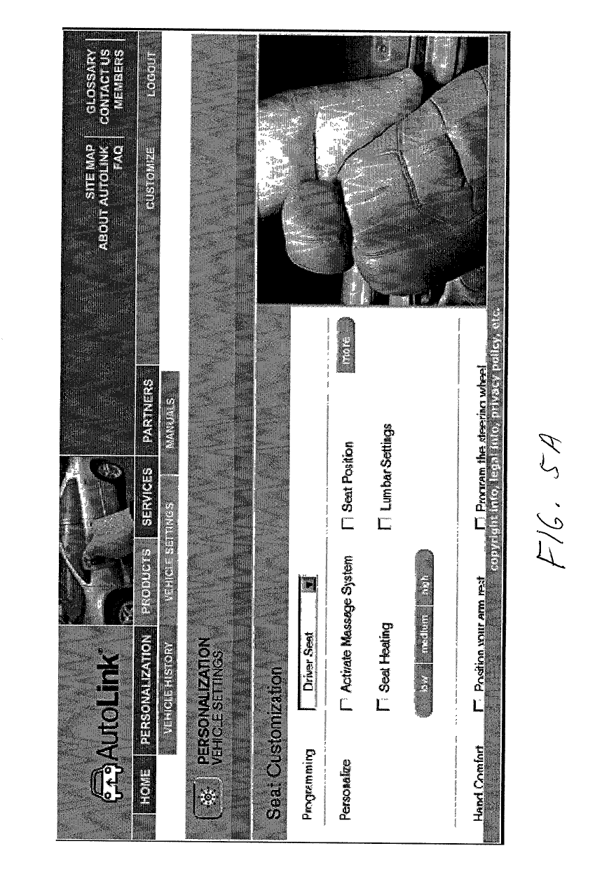

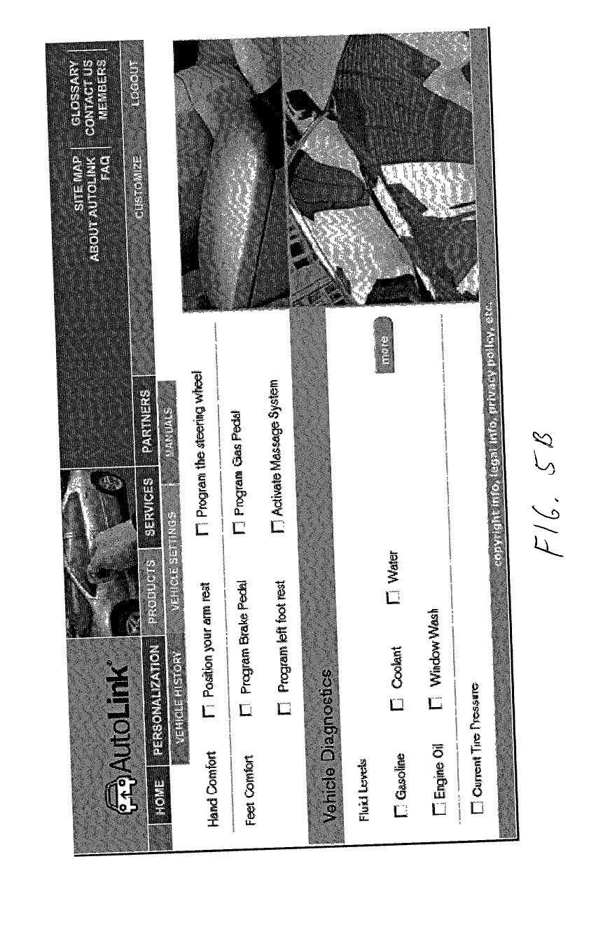

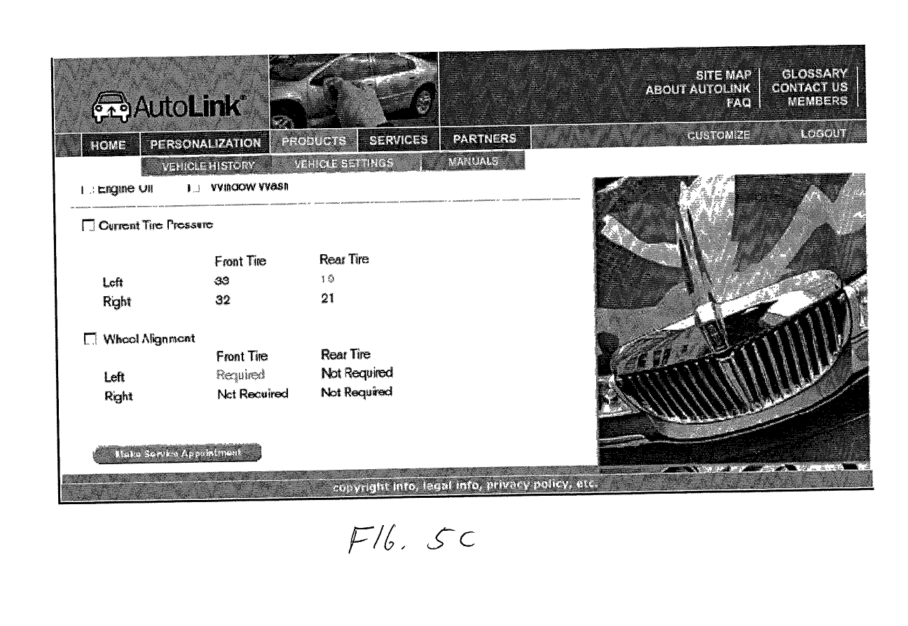

A user interface for providing vehicle history is depicted in FIG. 3. As depicted, a vehicle owner may enter a customer name, a customer address, a daytime phone number, a fax number, an e-mail address, service details, a vehicle identification number, a vehicle make/model, a vehicle color, a vehicle year, a vehicle license plate number, and a vehicle odometer reading, among other possible vehicle history details. This information may be entered in the build history link 310 page which allows entry of the details (see FIGS. 4A-4D).

A user may access service and warranty information by using link 320 which leads to a services and warranty screen depicted in FIG. 4. Services and warranty screen 400 may include a plurality of links including but not limited to a service link 410 which provides service details, maintenance logs, and any recall information relating to the user's vehicle. Accordingly, a user who is not aware of a product recall on a part of the vehicle may proceed to service link 410 and be apprised of such information. Services and warranty application 400 also includes a warranty link 420. Proceeding through link 420 will provide a user with specific warranty information regarding the user's vehicle. Accordingly, a user need not keep paper records of warranty information, the warranty information being retrievable and accessible on-line.

A dealer link 430 may also be included in interface 400. Dealer link 430 leads a user to dealers which are associated with the user's make and model of vehicle. Accordingly, a user need not search for vehicle dealers in their area, as such information will be readily provided to the user over the communications network. A reminder link 440 may also be provided through interface 400. Reminder link 440 provides maintenance reminders and the ability to schedule appointments with a service provider. Maintenance reminders may be configured by the user and may be provided upon access to reminders link 440 or, alternatively by other means, such as through an e-mail, conventional mail, or a telephone call from a service provider. Interface 400 may also include a vehicle history link 450. Vehicle history link 450 provides a user with a complete history view of the vehicle from the conception and the design phase to the present day activity, some of which has been provided by the vehicle owner. In a particular embodiment, vehicle history information may be input on a vehicle history building page exemplified in FIGS. 4A-4D. FIGS. 4A-4B show fields for entering claim/owner information, vehicle information, failure information, financial information, parts claimed, labor, other charges, and progressive damage charges. FIG. 4C depicts a page for inputting personalization of the automobile or vehicle including stereo system, seat customization, vehicle diagnostics, entertainment, safety and security options, and vehicle environment, continued in FIG. 4D. The personalization link allows a user to personalize the automobile, depicted in FIG. 4E and FIG. 4F by providing access to certain products and features. For example, stereo system link allows download of favorite songs into the vehicle stereo system as well as providing a plurality of customized stereo settings settable by a user. A comfortable fit application allows customization of seats, a vehicle diagnostics link provides diagnostics of the vehicle systems through a wireless link, a game link allows downloading of games for a user for a game interface in the vehicle, a safety and security link provides safety requirements for the vehicle, a climate controls link allows setting of environmental variables for the vehicle. Further, as depicted in FIG. 4F, a telematics link provides access to wireless systems, diagnostics, cellular phone, web browser, and interactive DVD for the vehicle. A vehicle diagnostics program provides a tire pressure monitoring system that notifies drivers when tire pressure is above or below acceptable levels, a road services link provides vehicle owners the ability to sign up with service providers nationally and internationally. An accessories link provides the vehicle owner's with seat options and more accessories that are available from product providers. A travel services link provides equipment GPS locator, driving directions and real time traffic updates, a listing of other products available to vehicle owners may also be provided, as depicted in FIG. 4F. For example, a link to a variety of driving schools, mechanics, and insurance providers may be provided.

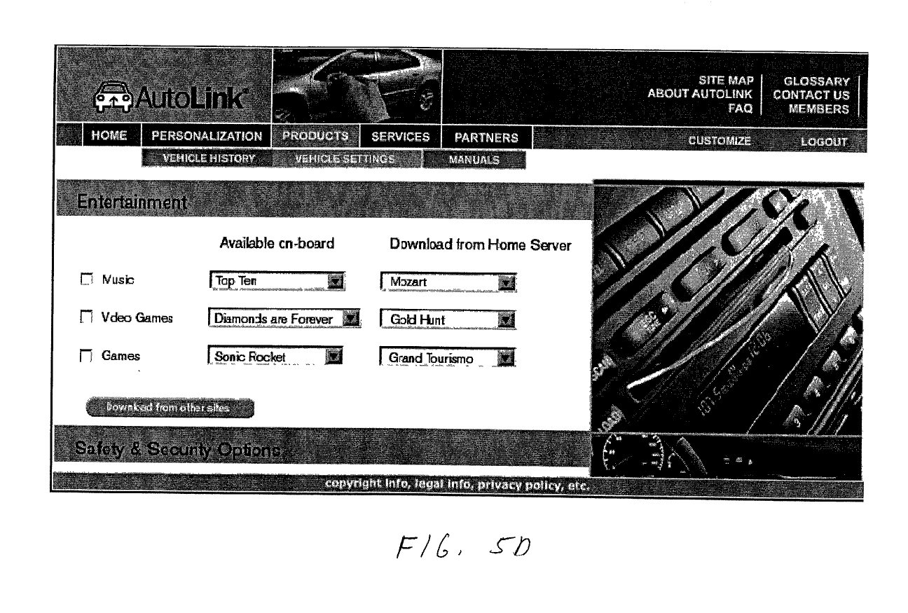

Referring now to FIG. 5, a personalization user interface 500 is depicted. Personalization user interface 500 is used to access vehicle history by vehicle history link 510. Vehicle history link 510 may provide access to vehicle content at the time of purchase, content added after purchase, possible future content, warranty information, etc. A vehicle settings link 520 is provided to access vehicle settings which may be stored and further may be downloaded to the individual vehicle. Vehicle settings may include but are not limited to sound systems, seats, climate, mirrors, lighting, security, communication, instrumentation, etc. Further, a manuals link 530 is provided. Manuals link 530 provides access to personalized manuals depending on customized equipment for the specific vehicle. Manuals may include, but are not limited to service, owners, stereo, security, phone, tires, etc. FIGS. 5A-5F depict further exemplary embodiments of user interfaces provided to a user to input information relating to personalization of the vehicle and/or the vehicle history and personalization database.

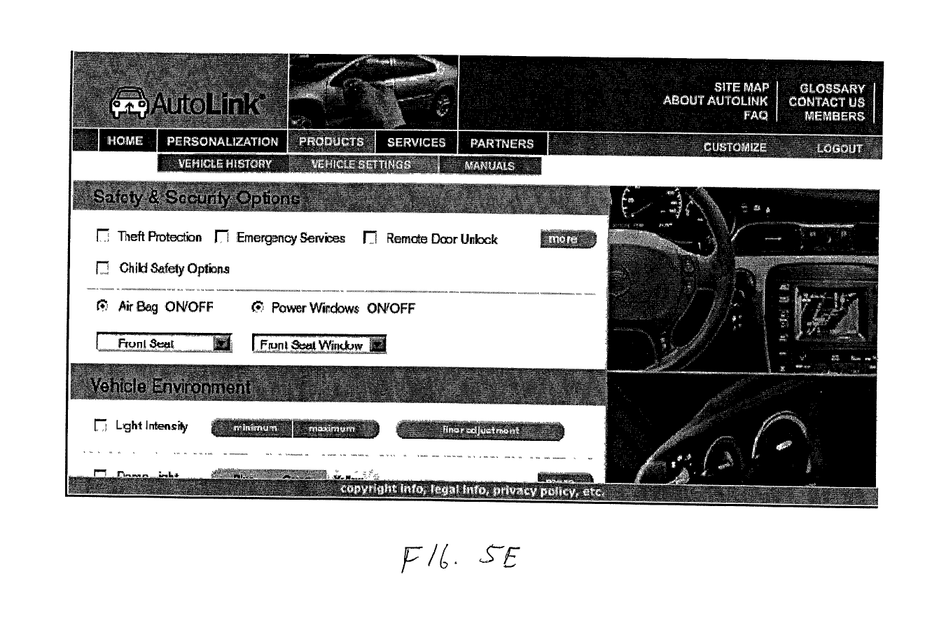

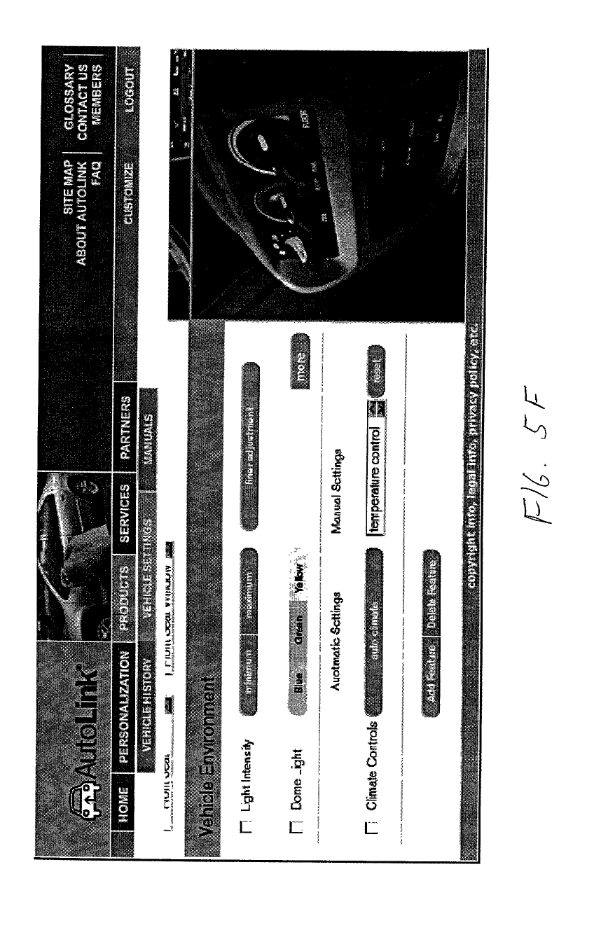

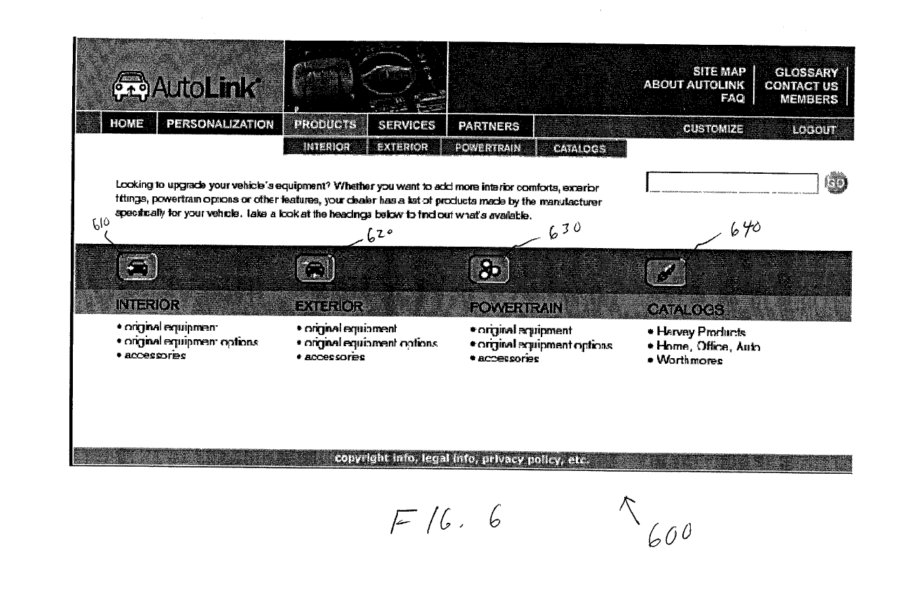

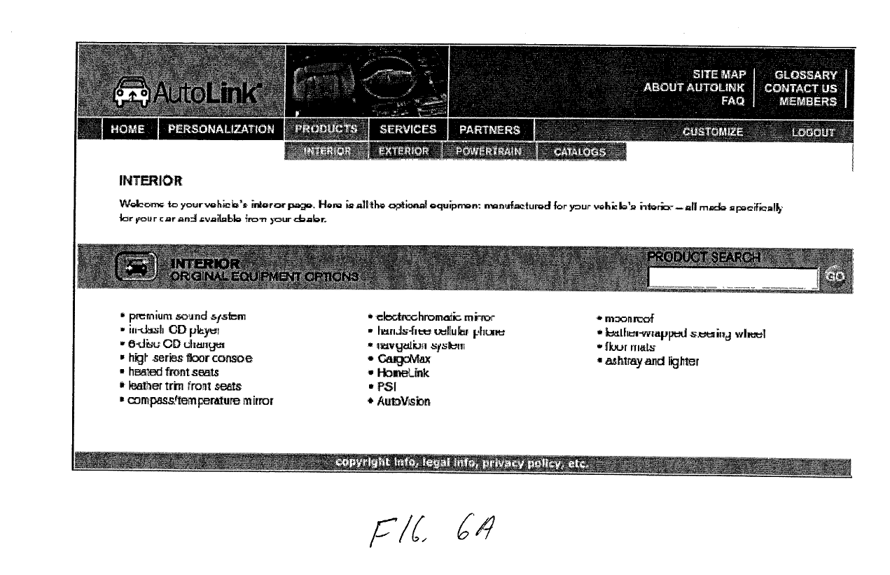

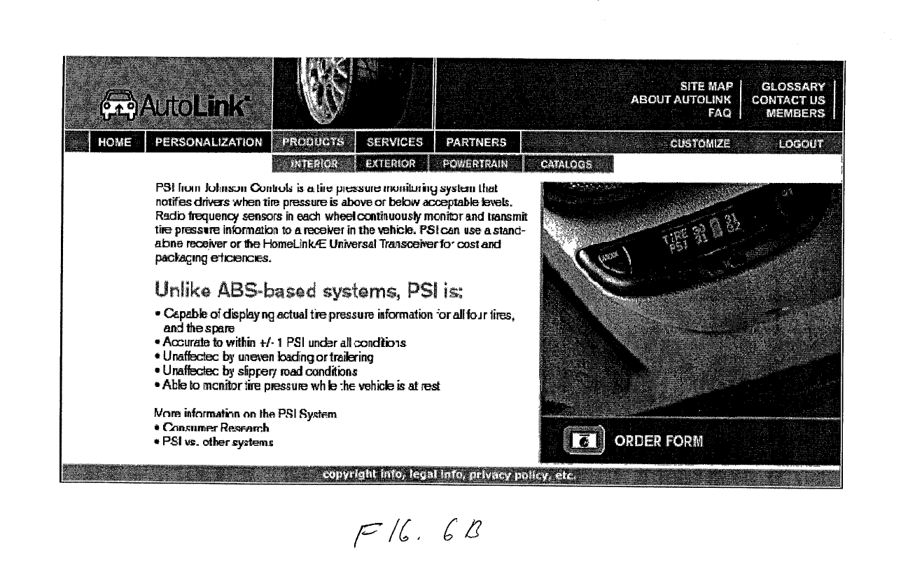

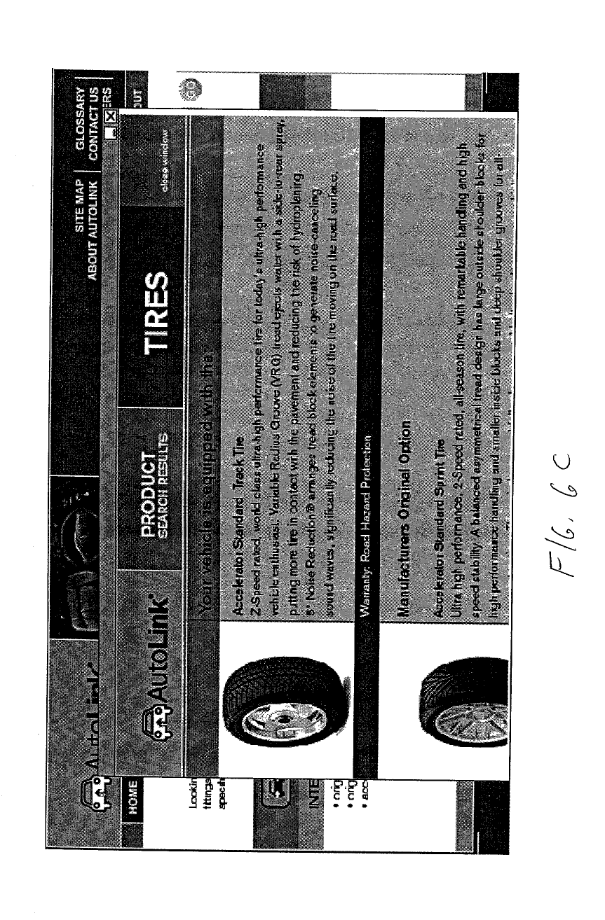

Referring now to FIG. 6, a products user interface 600 is depicted. Products user interface 600 is used to access vehicle interior products by vehicle interior products link 610. Vehicle interior products link 610 may provide access to vehicle interior product, including but not limited to, the vehicles original equipment, original equipment options, accessories, etc. A vehicle exterior products link 620 is provided to access vehicle exterior products. Vehicle exterior products may include but are not limited to vehicles original equipment, original equipment options, accessories, etc. Further, a vehicle powertrain link 630 is provided. Vehicle powertrain link 630 provides access to powertrain products for the vehicle. Pwertrain products may include, but are not limited to vehicles original equipment, original equipment options, accessories, etc. Further still, a catalogs link 640 is provided. Catalogs link 640 provides access to a variety of product catalogs by supplying links thereto or providing direct access to the catalogs. FIGS. 6A-6D depict further exemplary embodiments of user interfaces provided to access vehicle product information relating to vehicle products available for the specific individual vehicle.

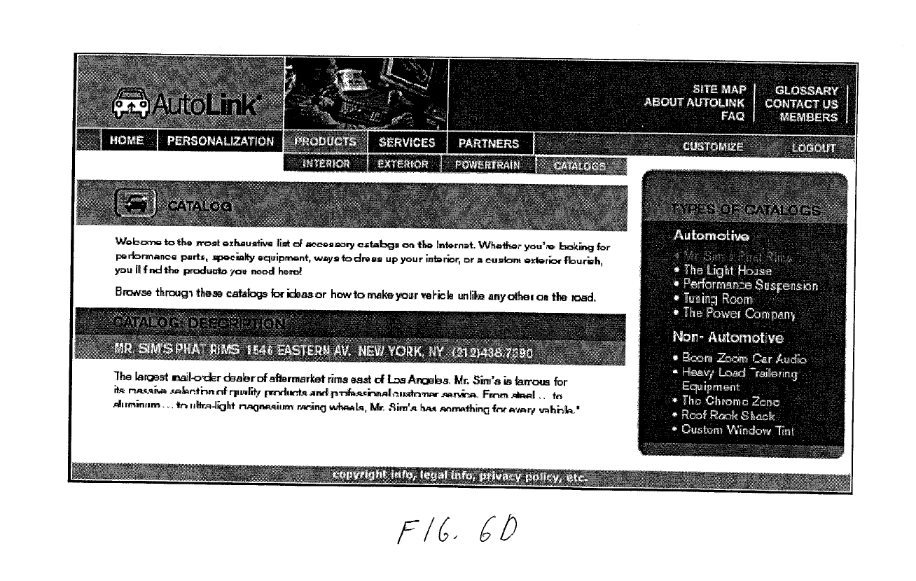

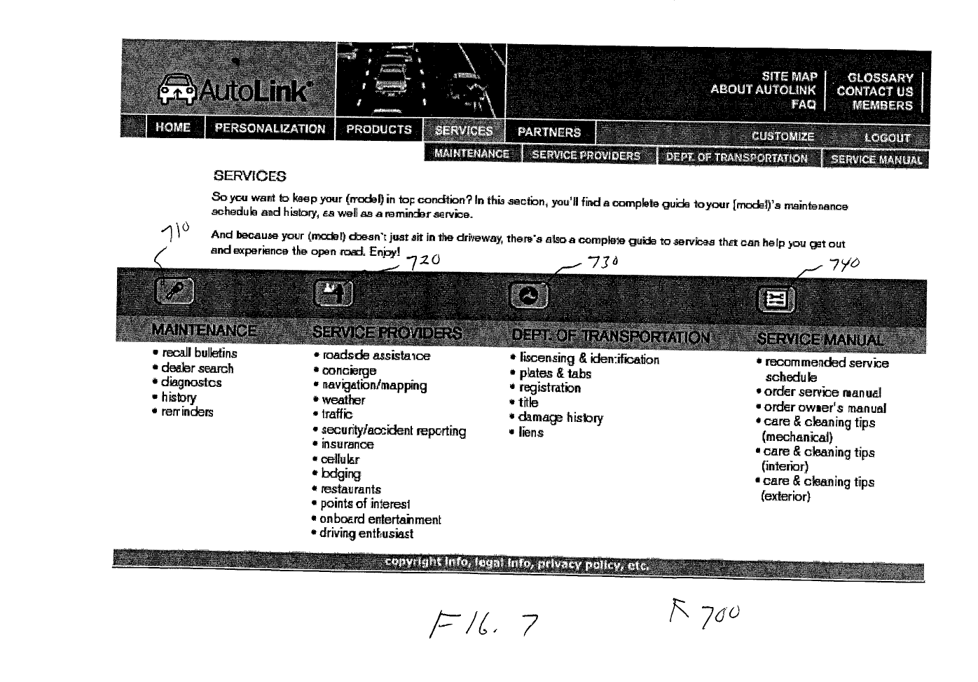

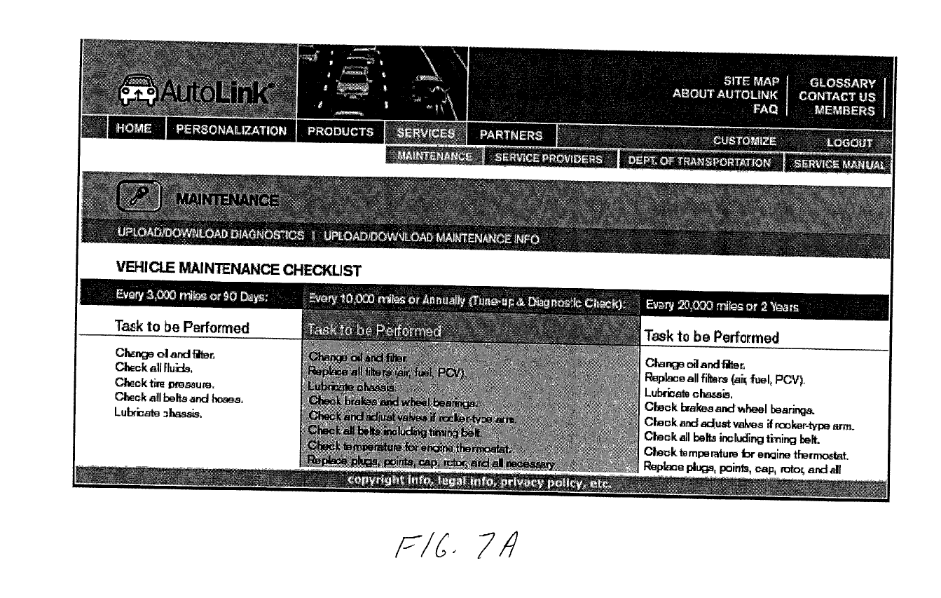

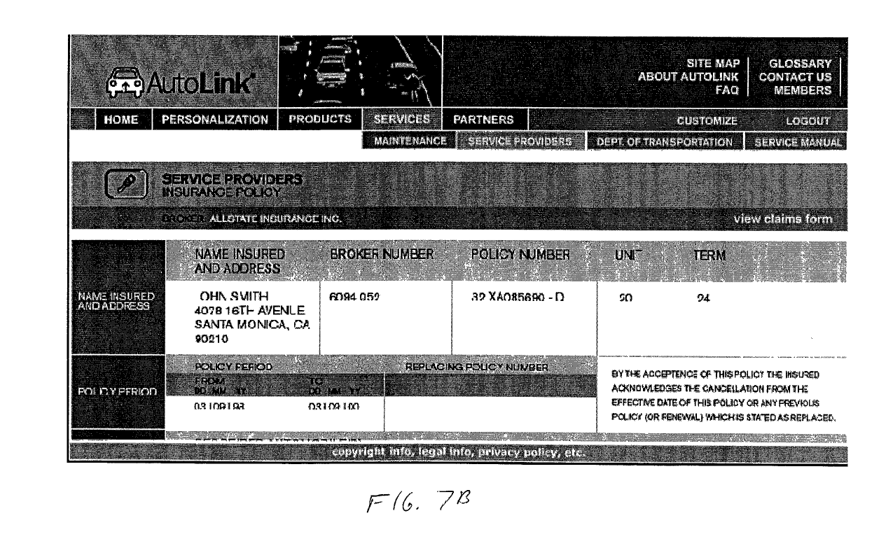

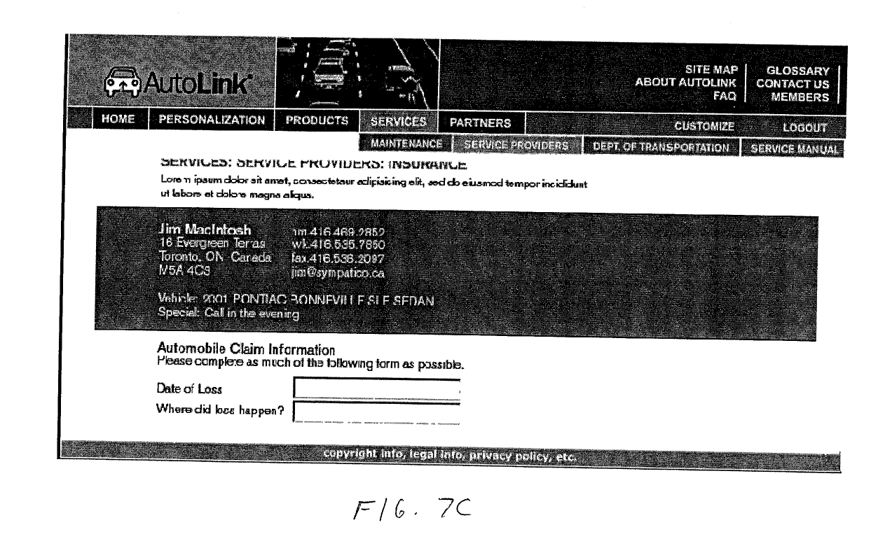

Referring now to FIG. 7, a services user interface 700 is depicted. Services user interface 700 is used to access vehicle maintenance information by vehicle maintenance information link 710. Vehicle maintenance information link 710 may provide access to vehicle maintenance information, including but not limited to, recall bulletins, dealer search, diagnostics, history, reminders, etc. A service providers link 720 is provided to access vehicle service providers. Vehicle service providers may include but are not limited to roadside assistance, concierge, navigation/mapping, weather, traffic, security/accident reporting, insurance, cellular, lodging, restaurants, points of interest, onboard entertainment, driving enthusiast, etc. Further, a Department of Transportation link 730 is provided. Department of Transportation link 730 provides access to Department of Transportation information which may include, but is not limited to licensing and identification, plates and tabs, registration, title, damage history, liens, etc. Further still, a service manual link 740 is provided. Service manual link 740 provides access to a variety of service manuals by supplying links thereto or providing direct access to the service manuals. Service manuals may include but are not limited to recommended service schedule, order service manual, order owner's manual, care and cleaning tips (mechanical), care and cleaning tips (interior), care and cleaning tips (exterior), etc. FIGS. 7A-7C depict further exemplary embodiments of user interfaces provided to access vehicle services manual for the specific individual vehicle.

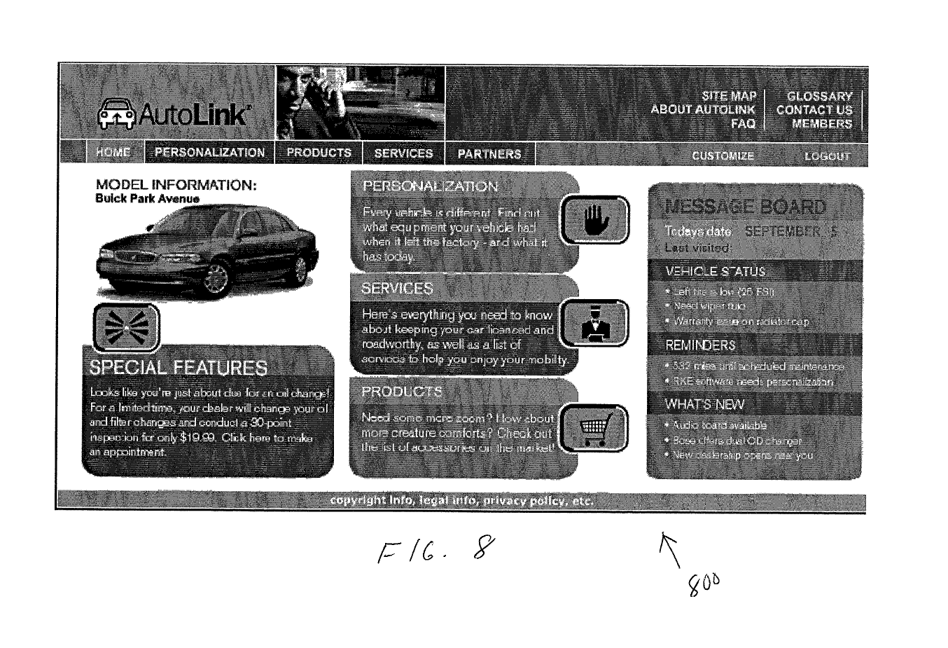

Referring now to FIG. 8, a alternative exemplary embodiment of an introductory or home page user interface 800 is depicted for a vehicle history and personalization system. User interface 800 may include personalization link 810, services link 820, and products link 830, among others. Other alternative configurations and combinations of links and functionality may be provided on any of the user interfaces previously disclosed without departing from the scope of the claims.

While the exemplary embodiments refer to terminals coupled to a central controller or central processor or centralized communications network, the invention may also be applied to internet browsing devices coupled to and in communication with the internet or any other communications network. The exemplary embodiments may encompass those situations in which any electronic devices are coupled to and in communication with a communications network.

Further still, those who have skill in the art will recognize that the invention is applicable with many different hardware configurations, software architectures, communications protocols, and organizations or processes.

While the detailed drawings, specific examples, and particular formulations given describe exemplary embodiments, they serve the purpose of illustration only. Materials and configurations shown and described may differ depending on the chosen performance characteristics and physical characteristics of the communications network. For example, the type of communications network or communication protocols used may differ. The systems shown and described are not limited to the precise details and conditions disclosed. Furthermore, other substitutions, modifications, changes, and omissions may be made in the design, operating conditions, information exchange, and arrangement of the exemplary embodiments of software and user interfaces, without departing from the scope of the invention that is expressed above.

What is claimed is:

1. A vehicle history system accessible by a plurality of users, comprising:
a communications network;
a server computer in communication with the communications network;
a client computer in communication with the communications network;
a vehicle history database accessible by the server computer, the vehicle history database including information for an individual vehicle relating to the design and manufacturing history of the individual vehicle;
a program running on the server computer, the program configured to provide access to vehicle specific data stored in the vehicle history database, based on a vehicle specific identifier provided to the server computer by the client computer.

2. The vehicle history system of claim 1, wherein the vehicle history database includes data for individual vehicles.

3. The vehicle history system of claim 1, wherein the vehicle history database includes data for classes of vehicles.

4. The vehicle history system of claim 1, wherein the vehicle history database includes data for vehicle warranty information.

5. The vehicle history system of claim 1, wherein the vehicle history database includes data for individual vehicles.

6. The vehicle history system of claim 1, wherein the vehicle history database includes service log data.

7. The vehicle history system of claim 1, wherein the vehicle specific identifier includes a vehicle identification number (VIN).

8. The vehicle history system of claim 1, wherein the vehicle history database includes after market product information for individual vehicles.

9. The vehicle history system of claim 1, wherein the vehicle history database includes data for individual vehicles.

10. The vehicle history system of claim 1, wherein the vehicle history database includes telematics data for individual vehicles.

11. The vehicle history system of claim 1, wherein the vehicle history database includes vehicle service links.

12. An on-line environment for accessing vehicle history, comprising:
a display;
a graphical user interface running on a computer and being viewed on the display;
a communications network in communication with the computer and having access to a vehicle history database;
a vehicle identifier field configured to utilize a vehicle identification number (VIN) to provide access to vehicle specific data, including vehicle history data and vehicle information data, the vehicle history data including information for individual vehicles relating to the design and manufacturing history of the individual vehicle.

13. The on-line environment of claim 12, wherein the vehicle history data includes data for vehicle warranty information.

14. The on-line environment of claim 12, wherein the vehicle history data includes data for classes of vehicles.

15. The on-line environment of claim 12, wherein the vehicle history data includes service log data.

16. The on-line environment of claim 12, wherein the vehicle history data includes after market product information for individual vehicles.

17. The vehicle history system of claim 12, wherein the vehicle history data includes data for individual vehicles.

18. The vehicle history system of claim 12, wherein the vehicle history data includes telematics data for individual vehicles.

19. The vehicle history system of claim 12, wherein the vehicle history data includes vehicle service links.

20. A method of retrieving vehicle specific data, comprising:
receiving over a communications network, from a user of a client computer a vehicle specific identifier;
retrieving over the communications network, from a database, vehicle history information;
providing over the communications network, to the client computer, vehicle history information for the specific vehicle, the vehicle history database including information for individual vehicles relating to the design and manufacturing history of the individual vehicle; and
providing over the communications network, access to vehicle specific data.

21. The method of claim 20, wherein the vehicle specific data includes telematics data or telematics functions.

22. The method of claim 20, wherein the vehicle specific data includes service and dealer links relating to the specific vehicle.

23. The method of claim 20, wherein the vehicle specific data includes warranty data.

24. The method of claim 20, wherein the vehicle specific data includes service log data.

25. A vehicle personalization, comprising:
a communications network;
a server computer in communication with the communications network;
a client computer in communication with the communications network;
a vehicle personalization database accessible by the server computer, the vehicle personalization database including information for an individual vehicle relating to the customization of the individual vehicle;
a program running on the server computer, the program configured to provide access to vehicle specific data stored in the vehicle personalization database, based on a vehicle specific identifier provided to the server computer by the client computer.

26. The vehicle personalization system of claim 25, wherein the program enables download of personalized settings to the vehicle.
